(19) United States
(12) Patent Application Publication
(10) Pub. No.: US 2005/0274594 A1
(43) Pub. Date: Dec. 15, 2005

(54) Metallic keypad and method for making the same

(76) Inventors: Yoon-Hong Yang, Seoul (KR); Eun-Ki Hong, Paju-city (KR); Jong-Il Lee, Suwon-city (KR)

Correspondence Address: FISH & RICHARDSON PC, P.O. BOX 1022, MINNEAPOLIS, MN, 55440-1022, US

(21) Appl. No.: 10/951,209

(22) Filed: Sep. 27, 2004

(30) Foreign Application Priority Data
Jun. 11, 2004 (KR) 10-2004-0042792
Aug. 10, 2004 (KR) 10-2004-0062832

(51) Int. Cl. H01H 3/12

(52) U.S. Cl. 200/341

(57) ABSTRACT

A method for making a metallic keypad includes the steps of forming a key using thermoplastic resin through an injection molding process, forming a conductive layer on a surface of the key, marking a function sign on the conductive layer, and forming a metal layer on the conductive layer except for the function sign.

### BACKGROUND OF THE INVENTION

1. Field of the Invention

The present invention relates to a keypad for a mobile phone and a method for making the same, and more particularly, to a keypad and a method for making the same that can securely maintain an attachment state of a metal layer formed to provide a feeling of metal and that can allow a variety of materials to be used.

2. Description of the Related Art

Generally, a keypad is a switch device used for a communication terminal such as a mobile phone and a personal digital assistant (PDA) to generate a signal or perform a variety of additional functions. The keypad has a plurality of keys on which letters or figures are printed, being assembled on a front housing of the terminal in a signal generatable state.

In the case of a mobile phone, the keypad presses a dome switch so that the dome switch can be elastically deformed to contact a contact point of a printed circuit board (PCB) and generate a signal, thereby performing a variety of functions provided by the mobile phone.

In order to manufacture such a keypad, plastic, silicon rubber, or a film having a predetermined thickness have been used. In addition, the keypad has been made in a variety of shapes.

In recent years, the keypad has been spray-coated or plated with metal to provide a metal-like sense, thereby improving its value and satisfying a variety of the user's requirements.

Such a metal-like keypad is realized by plating the metal material such as Cu, Ni, or Cr on a surface of a key formed of plastic material. Therefore, since the property of matter of the coated material is different from that of the key material, the coated metal material may be easily peeled away.

Furthermore, the metal material can be plated only when the keypad is formed of ACRYLONITRYL BUTADIENE STYRENE (ABS) resin. That is, the metal material is not plated on a key that is formed of other resins such as polycarbonate.

Therefore, to provide a metal-like key capable of back-lighting, a dual-injection molding process should be used, where an outer body of the key is first formed of ACRYLONITRYL BUTADIENE STYRENE (ABS) resin through an injection molding process and a central portion on which a letter or a numeral will be displayed is formed of another resin such as polycarbonate through another injection molding process. This manufacturing method makes it difficult to produce molds, increasing the manufacturing costs. Accordingly, the productivity of the keypads is deteriorated.

### SUMMARY OF THE INVENTION

Therefore, the present invention has been made in an effort to solve the above-described problems.

It is an objective of the present invention to provide a method for making a keypad that can make it possible to form a plated layer regardless of thermoplastic resin material and securely maintain the plated layer while being capable of back-lighting.

To achieve the above objective, the present invention provides a method for making a metallic keypad, comprising the steps of forming a key using thermoplastic resin through an injection molding process; forming a conductive layer on a surface of the key; marking a function sign on the conductive layer; and forming a metal layer on the conductive layer except for the function sign.

The conductive layer may be formed through an electroless plating process, having a thickness of about 0.1-5.0 μm.

The metal layer may be formed through a process selected from the group consisting of an electrolytic plating process, a sputtering process, a chemical vapor deposition process, and an electroless plating process.

The method may further comprise the step of forming a reinforced layer on the metal layer.

The key may be formed of semitransparent or transparent material so that the function sign can be brightly displayed during backlighting.

The conductive layer may be formed of material selected from the group consisting of Ni, Cr, Ti, and ITO. The metal layer may be formed of material selected from the group consisting of Cu, Ni, and Cr.

The method may further comprise the step of forming an etching portion on the surface of the key after the key is formed using the thermoplastic material.

The etching portion may be provided with minute projections formed on the surface of the key.

According to another aspect of the present invention, there is provided a keypad provided on a front housing of a mobile device, comprising a key formed of plastic material; a conductive layer formed on a surface of the key; a function sign formed on the conductive layer through a laser marking process or a photolithography process; and a metal layer formed on the conductive layer except for the function sign.

According to still another aspect of the present invention, there is provided a method for making a keypad for a mobile device, comprising the steps of forming a key using thermoplastic resin through an injection molding process; forming a conductive layer on a surface of the key; marking a function sign on the conductive layer; and forming a reinforced layer on the conductive layer except for the function sign.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a flowchart illustrating a method for making a metallic keypad according to an embodiment of the present invention; and

FIGS. 2a to 2f are views illustrating processes for making a metallic keypad according to a method depicted in FIG. 1.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

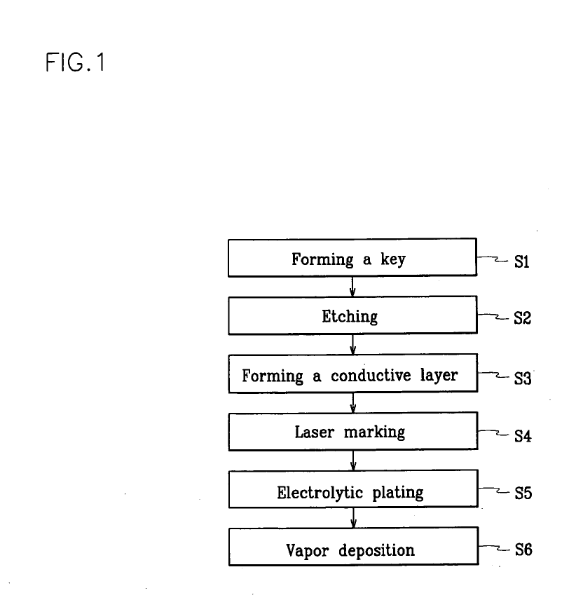

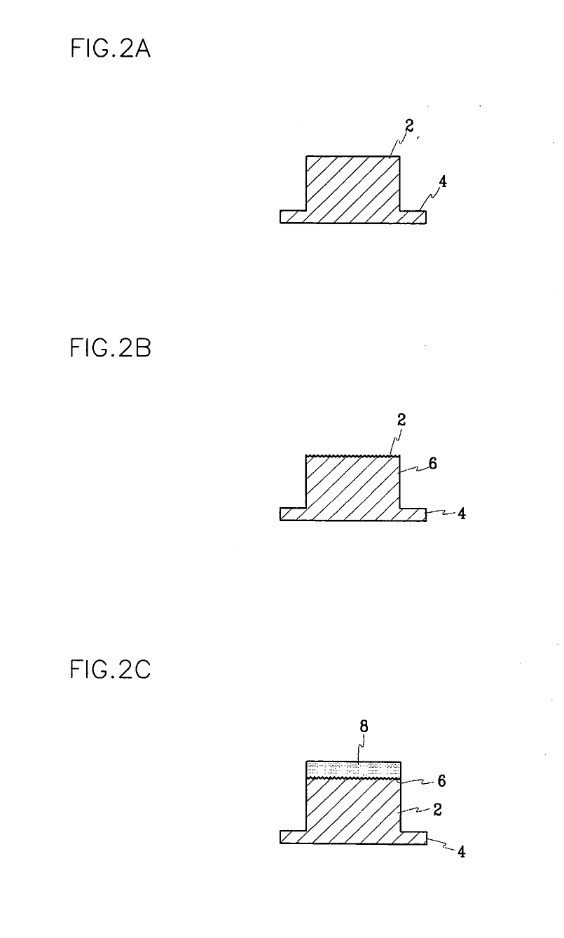

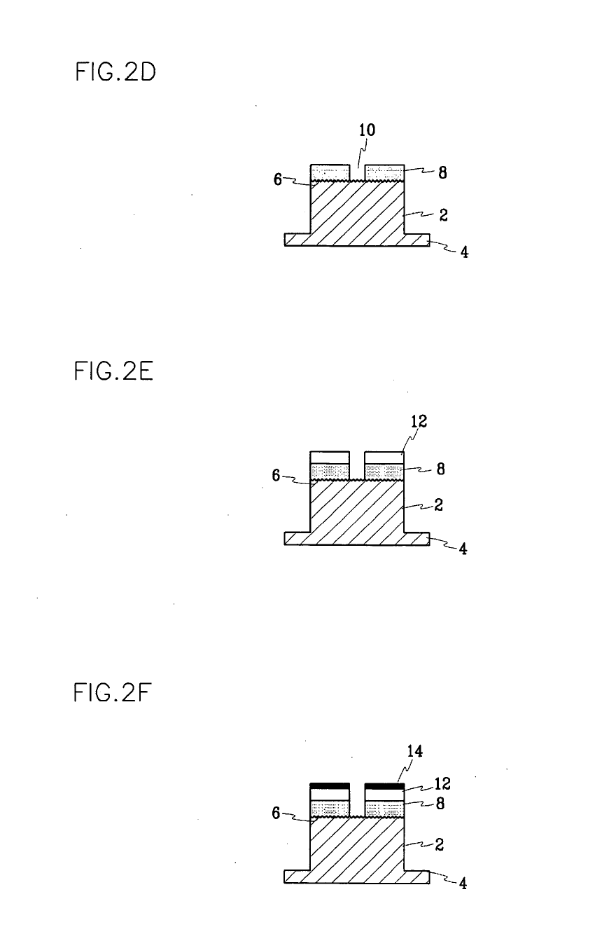

FIG. 1 is a flowchart illustrating a method for making a metallic keypad according to an embodiment of the present invention, and FIGS. 2a to 2f are views illustrating processes for making a metallic keypad according to a method depicted in FIG. 1.

In Step S1, a key as depicted in FIG. 2a is first formed through an injection molding process.

The key 2 may be formed of ABS resin or thermoplastic resin such as polycarbonate (PC) or poly methyl metha acrylate (PMMA) that cannot be used in association with a metal plating process.

It is preferable that the key 2 is formed of semitransparent or transparent material so that a letter or a numeral on the key 2 can be brightly displayed during the back-lighting.

The key 2 is provided at a lower portion with a flange 4 that can interrupt light emitted from a backlight assembled on a housing of a mobile device and prevents the key from being removed from the housing.

In Step S2, as shown in FIG. 2b, an etching portion 6 is formed on a surface of the key 2 by physically or chemically activating the surface of the key 2. The etching portion 6 is provided to enhance the attaching force of metal material on the surface of the key 2 formed of nonconductive material.

In order to form the etching portion 6, there are physical and chemical methods. In the physical method, plasma or ion beam is eradiated to form minute projections on the surface of the key 2.

Alternatively, an intermediate layer such as a seed layer may be deposited on the surface of the key to define the etching portion 6.

In the chemical method of Step S2, chemical agent such as nitric acid liquid may be applied to the surface of the key 2 to corrode the surface, thereby forming grooves and projections on the surface.

After the etching portion 6 is formed in Step S2, a conductive layer 8 is formed utilizing the etching portion 6 in Step S3.

At this point, the conductive layer 8 is formed of Ni, Cr, Ti, or the like, that has resistance against an acid plating process. It is preferable that a thickness of the conductive layer 8 is in a range of 0.1-0.5 μm so that laser marking is possible in a following process.

In Step S4, a laser marking process is performed to form a display portion such as the letter or numeral on the conductive layer 8 formed on the key 2. By this process, the display portion 10 becomes a nonconductive portion where the conductive layer is removed.

Alternatively, the display portion 10 may be formed through a conventional photolithography process.

In Step S5, as shown in FIG. 2e, a metal layer 12 is formed on the conductive layer 8 except for the display portion 10 through an electrolytic plating process S5 so as to improve the attaching force and endurance of the conductive layer 8 and provide the feeling of metal to the key 2.

In the electrolytic plating process S5, Cu, Ni, Cr, or the like, that can well represent the feeling of metal may be used as electrolytic material.

The electrolytic plating process can be replaced with a sputtering method, a chemical vapor deposition method, or an electroless plating method.

After the above, the key 2 represents the feeling of metal by the metal layer 12. The producing process of the key 2 can be finished in this state. However, as shown in FIG. 2f, a reinforced layer 14 may be further formed through a deposition process S6 to improve the product value.

To form the reinforced layer 14, a sputtering method is used to deposit a thin metal layer on the surface of the metal layer 12.

The reinforced layer 14 may be formed of metal such as TiN, SUS, Au, and the like, that can provide a high-class quality.

The key formed through the above Steps is attached on a base member and inserted in the front housing of the mobile device such as a mobile phone.

When the key is assembled on the housing, the metal layer 12 deposited on the surface of the key 2 provides the feeling of metal, improving the product value and the effect of the sense of sight.

According to the present invention, since the conductive layer is formed on a plastic key through an electroless plating process and the metal layer is plated on the conductive layer through the electrolytic plating process, the metal layer can be formed on the key regardless of the kind of material of the key.

Furthermore, since the injection molding process can be easily performed, the productivity can be improved, reducing the manufacturing costs.

In addition, since the metal layer is formed around the display portion, the possible damage of the display portion can be prevented.

Since the reinforced layer is formed on the metal layer, the product value and the product image can be improved. When the reinforced layer is directly formed on the conductive layer without forming the metal layer, the process may be further simplified.

Since the conductive layer is formed on the etching portion of the key, the attaching force of the conductive layer may be further improved, thereby improving the endurance of the metallic key.

It will be apparent to those skilled in the art that various modifications and variations can be made in the present invention. Thus, it is intended that the present invention covers the modifications and variations of this invention provided they come within the scope of the appended claims and their equivalents.

For example, in the above embodiment, the reinforced layer 14 is formed after the metal layer 12 is formed. However, the present invention is not limited to this. That is, the reinforced layer 14 can be directly formed on the conductive layer 8 without performing the electrolytic plating process after the marking process S4. In this case, the number of processes can be reduced.

1. A method for making a metallic keypad, comprising the steps of:
forming a key using thermoplastic resin through an injection molding process;
forming a conductive layer on a surface of the key;
marking a function sign on the conductive layer; and
forming a metal layer on the conductive layer except for the function sign.

2. The method of claim 1, wherein the conductive layer is formed through an electroless plating process, having a thickness of about 0.1-5.0 μm.

3. The method of claim 1, wherein the metal layer is formed through a process selected from the group consisting of an electrolytic plating process, a sputtering process, a chemical vapor deposition process, and an electroless plating process.

4. The method of claim 1, further comprising the step of forming a reinforced layer on the metal layer.

5. The method of claim 1, wherein the key is formed of semitransparent or transparent material so that the function sign can be brightly displayed during backlighting.

6. The method of claim 1, wherein the conductive layer is formed of material selected from the group consisting of Ni, Cr, Ti, and ITO.

7. The method of claim 1, wherein the metal layer is formed of material selected from the group consisting of Cu, Ni, and Cr.

8. The method of claim 1, further comprising the step of forming an etching portion on the surface of the key after the key is formed using the thermoplastic material.

9. The method of claim 8, wherein the etching portion is provided with minute projections formed on the surface of the key.

10. A keypad provided on a front housing of a mobile device, comprising:
a key formed of plastic material;
a conductive layer formed on a surface of the key;
a function sign formed on the conductive layer through a laser marking process or a photolithography process; and
a metal layer formed on the conductive layer except for the function sign.

11. The keypad of claim 10, further comprising a reinforcing layer formed on the metal layer.

12. The keypad of claim 10, wherein the surface of the key is provided with an etching portion.

13. The keypad of claim 10, wherein the key is provided at a lower portion with a flange.

14. The keypad of claim 10, wherein the key is formed of material selected from the group consisting of acrylonitryl butadiene styrene resin, polycarbonate, and poly methyl metha acrylate.

15. A method for making a keypad for a mobile device, comprising the steps of:
forming a key using thermoplastic resin through an injection molding process;
forming a conductive layer on a surface of the key;
marking a function sign on the conductive layer; and
forming a reinforced layer on the conductive layer except for the function sign.
